(19) United States
(12) Patent Application Publication
(10) Pub. No.: US 2026/0220519 A1
(43) Pub. Date: Jul. 30, 2026

(54) INFORMATION HANDLING SYSTEM WITH AUTHENTICATION OF MACHINE LEARNING MODEL RUNTIME BUNDLES

(71) Applicant: DELL PRODUCTS L.P., Round Rock, TX (US)

(72) Inventors: Jacob Mink, Cedar Park, TX (US); Robert Bacher, Asheville, NC (US); Nicholas Grobelny, Evergreen, CO (US)

(21) Appl. No.: 19/036,164

(22) Filed: Jan. 24, 2025

(51) Int. Cl. G06N 20/00

(52) U.S. Cl. CPC G06N 20/00

(57) ABSTRACT

An information handling unpacks a machine learning model to create a machine learning model and extract artifacts of the machine learning model. The system determines a behavior of the machine learning model based on sample inputs and compares the behavior of the machine learning model to expected behavior manifest limits for the machine learning model. In response to the behavior being below the expected behavior manifest limits, the system hashes the artifacts and stores the hash of the artifacts in the memory.

### FIELD OF THE DISCLOSURE

The present disclosure generally relates to information handling systems, and more particularly relates to authenticating machine learning model runtime bundles within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store a packed machine learning model, and may unpack the packed machine learning model to create a machine learning model and extract artifacts of the machine learning model. The system may determine a behavior of the machine learning model based on sample inputs and compare the behavior of the machine learning model to expected behavior manifest limits for the machine learning model. In response to the behavior being below the expected behavior manifest limits, the system may hash the artifacts and store the hash of the artifacts in the memory.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system including an information handling system and a remote server according to at least one embodiment of the present disclosure;

FIG. 2 is a flow diagram of a method for creating a validated model including an expected behavior manifest for deployment to an information handling system according to at least one embodiment of the present disclosure;

FIG. 3 is a flow diagram of a method for validating a model based on an expected behavior manifest of the model within an information handling system according to at least one embodiment of the present disclosure; and

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. this focus should not be interpreted as a limitation on the scope or applicability of the teachings.

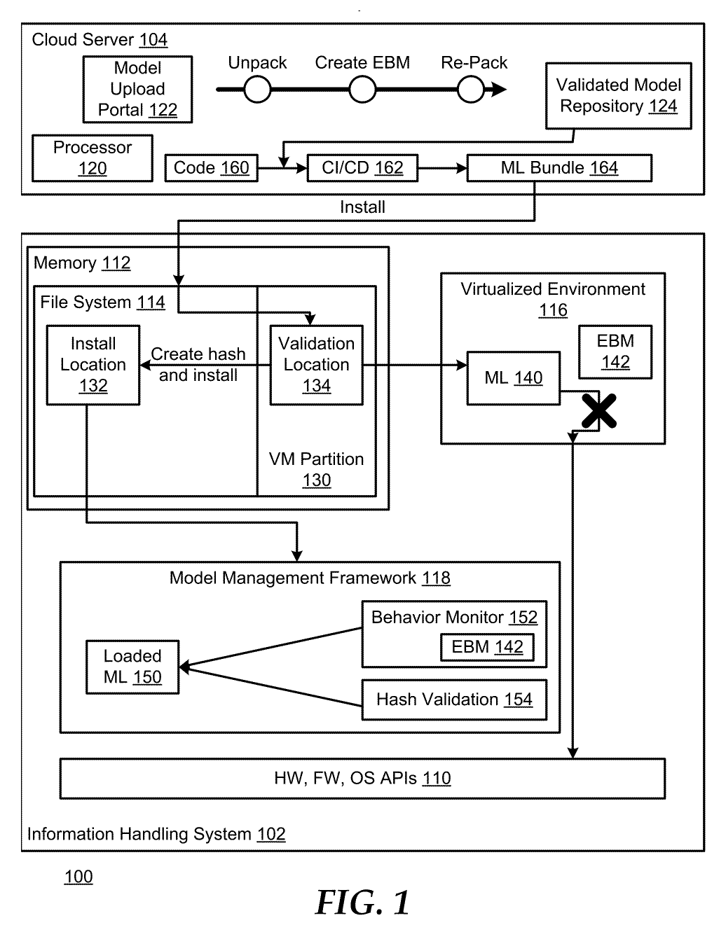

FIG. 1 illustrates a system 100 including an information handling system 102 and a remote or cloud server 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes hardware, firmware, operating system (OS) application programing interface (API) 110, a memory 112 including a file system 114, a virtualized environment 116, and a model management framework 118. In an example, the hardware may include a processor, a graphics processing unit (GPU), a neural processing unit (NPU), or any other suitable components to execute a machine learning (ML) model within information handling system 102. Remote server 104 includes a processor 120, a model upload portal 122, and a validated model repository 124. Information handling system 102 and remote server 104 may include additional components without varying from the scope of this disclosure.

In an example, file system 114 of memory 112 includes a virtual machine (VM) partition 130 and an installation location 132 in the file system. VM partition includes a validation location 134 of file system 114. Virtualized environment 116 may store and execute ML model 140 based on an expected behavior manifest (EBM) 142 as will be described below. Model management framework 118 may execute a loaded ML model 150, monitor the behavior of the ML model 152 based on EBM 142, and validate hashes of ML model artifacts 154 as will be described below.

In certain example, ML models may be subject to attacks in different ways than traditional software. For example, in an automatically deployed and distributed mesh environment, trusting the physical model binary at runtime is a problem not currently handled by the current open source frameworks. Models should operate on their inputs only, but serialization formats for models may be vulnerable to remote code execution (RCE) attacks. Within ML models, these vulnerabilities may be different/more obscure due to the structure of computation provided by these tools. Additionally, components of ML models may be vulnerable to traditional software attacks when left unprotected. Information handling system 102 may be improved and protected by processor 110 authenticating ML model runtime bundles received from cloud server 104 as will be described herein.

During operation of cloud server 104, processor 120 may receive a signed ML model bundle file via model upload portal 122. In an example, this ML model bundle may be received from a vendor or model producer. The ML model bundle may include artifacts for the ML model, such as a collection of binaries, configuration, weights/biases, or the like. This ML model bundle may be compressed or saved in any suitable file format, such as a cabinet (.CAB) file.

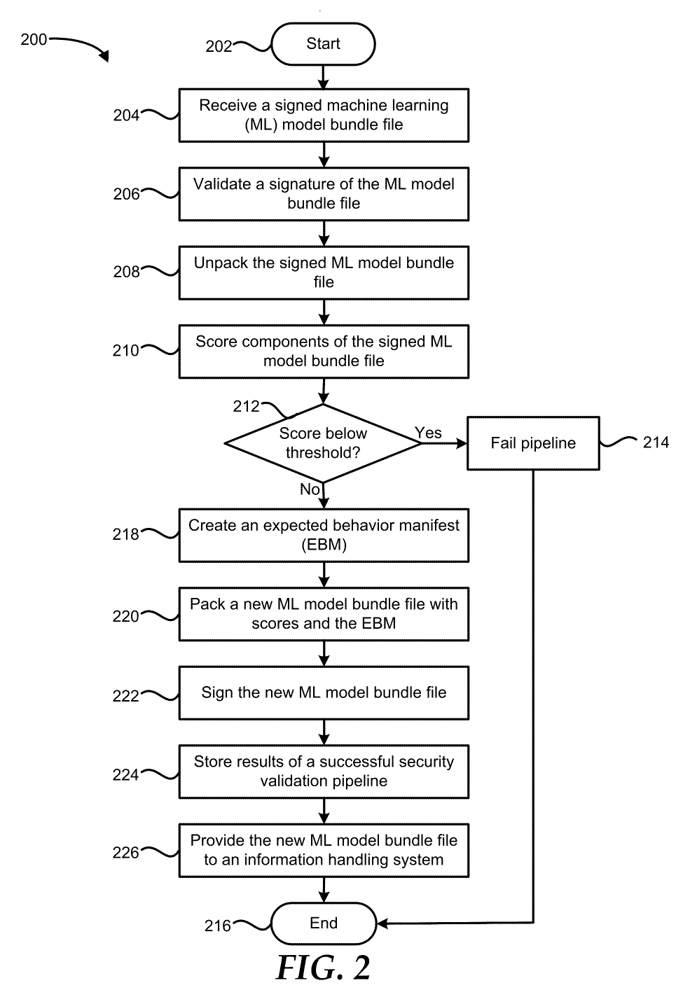

In response to the ML bundle being received, processor 120 may automatically being a security validation pipeline for the artifacts of the ML model within the bundle. During the validation of the ML bundle, processor 120 may validate the signature of the ML model bundle. In an example, the signature may be verified via any suitable file signature validation operations know in the art. In certain examples, the security validation pipeline is illustrated in FIG. 2 as the flow including unpack, create EBM, and repack. In an example, processor 120 may unpack the ML model bundle to retrieve the ML model code 160 and other artifacts of the ML model. After the ML model bundle is unpacked, processor 120 may perform one or more operations on code 160 in a continuous integration and continuous delivery (CI/CD) pipeline 162. In an example, CI/CD pipeline 162 may be an automated workflow to integrate code into a ML model bundle 164.

During execution of CI/CD pipeline 162, referred to herein as pipeline 162, processor 120 may score the components of the ML model. The scoring of the components may be based on any suitable factors including, but not limited to, risk and impact of the ML model code and artifacts on an information handling system, such as information handling system 102. Processor 120 may determine whether the score of the ML model is below a threshold level. In an example, the threshold level may be configurable by a company or organization associated with information handling system 102 in communication with remote server 104. If the score is below the threshold, processor 120 may fail pipeline 162 so that ML model bundle 164 is not created for deployment to information handling system 102.

If the score is above the threshold level, processor 120 may create EBM 142 for a ML model in ML model bundle 164. The EBM may be created based on the declared ML model and component behavior, the artifacts for the ML model, the calculated scores, and example inputs to the ML model. In an example, processor 120 may pack ML model bundle file 164 to include the scores and the EBM for the ML model. In an example, processor 120 may sign ML model bundle file 164. Additionally, processor 120 may store results of a successful security validation of pipeline 162 in validated model repository 124. In an example, the results may be stored as read-only use by developers, the continuous integration and continuous delivery CI/CD pipeline 162, and deployment of ML model bundle 164. Processor 120 may provide signed ML model bundle 164 to information handling system 102.

In response to ML model bundle 164 being received at information handling system 102, processor 110 may automatically perform a first-time operation to authenticate ML model runtime bundle 164. In certain examples, ML model bundle 164 may include the runtime code for ML model 140, EBM 142, the artifacts for the ML model, and any other executable code required by a core agent to execute ML model 140.

In an example, processor 110 may deploy or stored the artifacts in validation location 134 of VM partition 130. In certain examples, VM partition 130 may be a protected and isolated partition of memory 112. Processor 110 may unpack ML model 140 from ML model bundle 164. In certain examples, ML model 140 may be stored in validation location 134. In certain examples, processor 110 may execute ML model 140 with sample inputs. In an example, processor 110 may execute ML model 140 within virtualized environment 116 to validate the ML model stored in validation location 134 before execution of ML model 140 with model management framework 118. Virtualized environment 116 may include hooks that, based on EBM 142, report errors, warnings, and failures in response to any unexpected access to information handling system 102 by the model code. In an example, a behavior of the ML model may differ from the EBM behaviors if the ML model tries to access OS API, which is not allowed by EBM behaviors 142 as indicated by the ‘X’ in FIG. 1.

During execution of ML model 140, processor 110 may determine whether the behavior of the ML model 140 with the sample inputs exceeds EBM limits 142 for the ML model. These EBM limits 142 may be included in ML model bundle 164. If the behavior of ML model 140 exceeds EBM limits 142, processor 100 may fail the extraction of ML model 140. If the behavior does not exceed the EBM limits, processor 110 may hash the artifacts in ML model 140. In an example, processor 110 may store the hash of the artifacts in install location 132 for future validation of ML model 140.

During a startup of a core application, processor 110 may perform hash validation 154 to validate the artifacts in loaded ML model 150 against the previously stored hash of the artifacts. In an example, loaded ML model 150 may be substantially similar to ML model 140 when the artifacts in the loaded ML model match the stored hash of the artifacts. In response to the artifacts being validated, the artifacts are loaded for execution by the processor. During the execution of loaded ML model 150 by the application of processor 110, the behaviors of the ML model are monitored. In certain examples, processor 110 may perform behavior monitor 152 of loaded ML model 150 against EBM 142. In an example, the behaviors may be the results of loaded ML model 150 based on the inputs provided to the model. If the behavior of loaded ML model 150 changes or differs from EBM behaviors 140, the ML model is removed from processor 110 and quarantined. As described above, one possible circumstance of a behavior of loaded ML model 150 differing from EBM behaviors 142 may be if the ML model tries to access an OS API, which is not allowed by the EBM behaviors.

FIG. 2 shows a method 200 for creating a validated model including an expected behavior manifest for deployment to an information handling system according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, processor 120 of remote server 104 in FIG. 1, or any other type of controller, device, module, processor, or any combination thereof, operable to employ all, or portions of, the method of FIG. 2.

At block 204, a signed ML model bundle file is received. In an example, this ML model bundle may be received in a remote server from a vendor or model producer. In certain examples, the remote server may be a secure cloud server. The ML model bundle may include artifacts for the ML model, such as a collection of binaries, configuration, weights/biases, or the like. This ML model bundle may be compressed or saved in any suitable file format, such as a cabinet (.CAB) file.

At block 206, the signature of the ML model bundle file is validated. In an example, the signature may be verified via any suitable file signature validation operations know in the art. At block 208, the ML model bundle is unpacked. In certain examples, a processor of the remote server may unpack the ML model bundle to enable access to the artifacts of the ML model. At block 210, components of the ML model bundle are scored. The scoring of the components may be based on any suitable factors including, but not limited to, risk and impact of the ML model code and artifacts.

At block 212, a determination is made whether the score is below a threshold level. The threshold level may be configurable by a company or organization associated with an information handling system in communication with the remote server. If the score is below the threshold, the pipeline of creating a new ML model bundle file is failed at block 214 and the flow ends at block 216. In an example, the pipeline may be a continuous integration and continuous delivery (CI/CD) pipeline, which is an automated workflow to integrate code into the ML model.

If the score is above the threshold level, an expected behavior manifest (EBM) is created for the ML model at block 218. The EBM may be created based on the declared ML model and component behavior, the artifacts for the ML model, the calculated scores, and example inputs to the ML model.

At block 220, a new ML model bundle file is packed to include the scores and the EBM for the ML model. At block 222, the new ML model bundle file is signed. At block 224, results of a successful security validation of the pipeline are stored in a memory of the remote server. In an example, the results may be stored as read-only use by developers, the continuous integration and continuous delivery CI/CD pipeline, and deployment of the ML model bundle. At block 226, the new signed ML model bundle is provided to an information handling system and the flow ends at block 216.

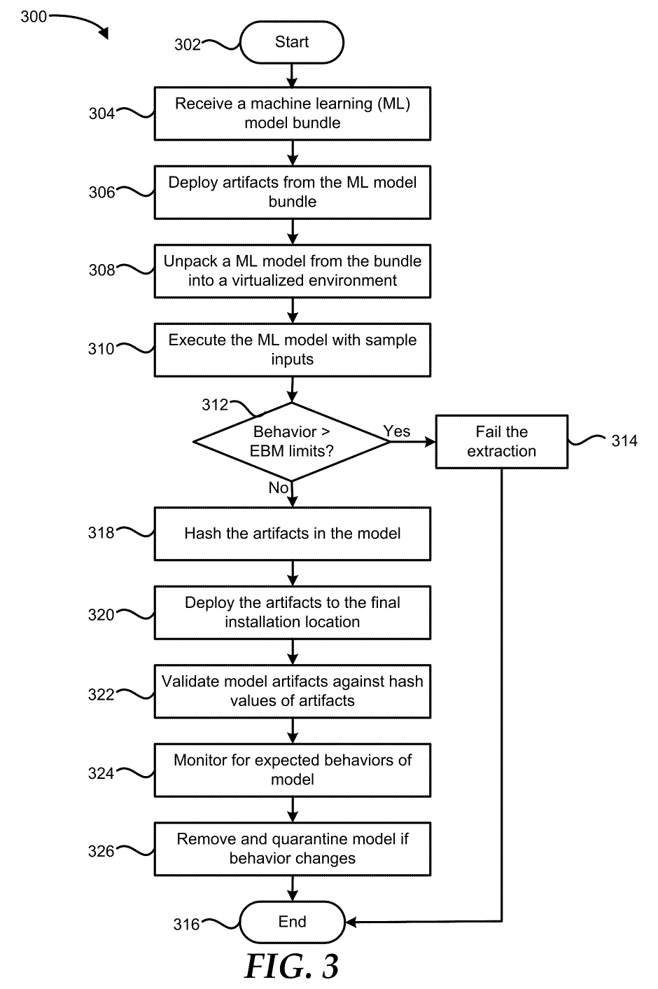

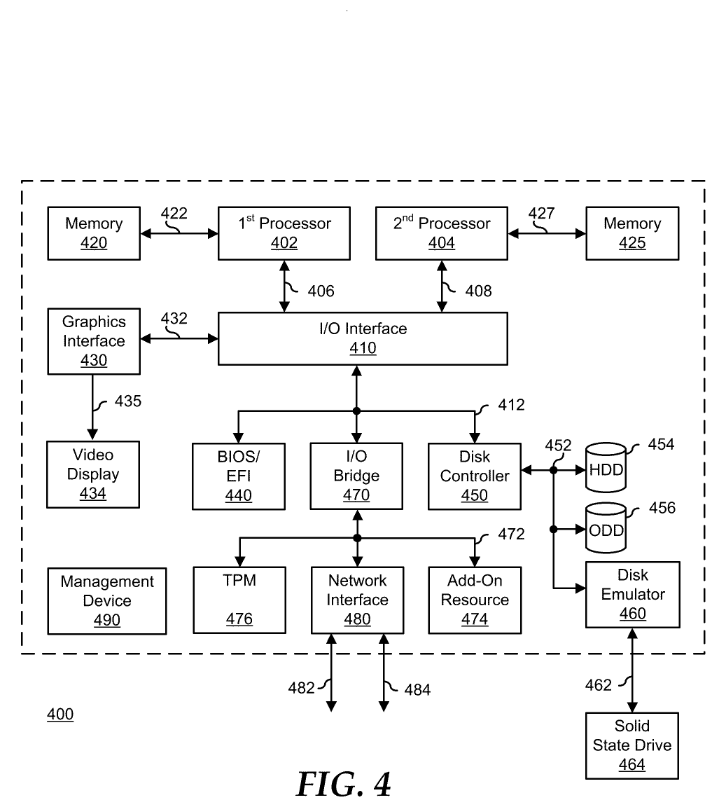

FIG. 3 shows a method 300 for validating a model based on an expected behavior manifest of the model within an information handling system according to at least one embodiment of the present disclosure, starting at block 302. Not every method step set forth in this flow diagram is always necessary, and certain steps of the methods may be combined, performed simultaneously, in a different order, or perhaps omitted, without varying from the scope of the disclosure. FIG. 3 may be employed in whole, or in part, processor 110 of information handling system 102 in FIG. 1, or any other type of controller, device, module, processor, or any combination thereof, operable to employ all, or portions of, the method of FIG. 3.

At block 304, a ML model bundle is received. In an example, a processor of an information handling system may receive the ML model bundle, which in turn may be signed and received from a remote server. In certain examples, the ML model bundle may include the ML model runtime code, the EBM for the ML model, the artifacts for the ML model, and any other executable code required by a core agent to execute the ML model.

At block 306, the artifacts are deployed or stored. In an example, the artifacts may be stored in a protected and isolated memory of the information handling system. At block 308, the ML model is unpacked from the ML model bundle. In certain examples, the ML model may be stored in a virtualized environment within the information handling system. The virtualized environment may include hooks that, based on the EBM, report errors, warnings, and failures in response to any unexpected access to the information handling system by the model code.

At block 310, the ML model is executed with sample inputs. At block 312, a determination is made whether the behavior of the ML model with the sample inputs exceeds the EBM limits for the ML model. These EBM limits may be included in the ML model bundle received from the remote server. If the behavior of the ML model exceeds the EBM limits, the extraction of the ML model is failed at block 314 and the flow ends at block 316.

If the behavior does not exceed the EBM limits, the artifacts in the ML model are hashed at block 318. In an example, the hash of the artifacts may be stored for future validation of the ML model. At block 320, the artifacts are deployed or stored in a final installation location of a memory in the information handling system. In certain examples, blocks 308-320 may be performed during a first-time operation of the processor when the ML model bundle is received from the remote server.

At block 322, artifacts in the ML model are validated against the previously stored hash of the artifacts. In response to the artifacts being validated, the artifacts are loaded for execution by the processor. At block 324, the behaviors of the ML model are monitored. In an example, the behaviors are the results of the ML model based on the inputs provided to the model. The behaviors of the ML model may be compared to the EBM behaviors received in the ML model bundle. If the behavior of the ML model changes or differs from the EBM behaviors, the ML model is removed from the processor and quarantined at block 326 and the flow ends at block 316. In an example, a behavior of the ML model may differ from the EBM behaviors if the ML model tries to access an operating system (OS) application programing interface (API), which is not allowed by the EBM behaviors.

FIG. 4 shows a generalized embodiment of an information handling system 400 according to an embodiment of the present disclosure. Information handling system 400 may be substantially similar to information handling system 102 of FIG. 1. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456 , a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a machine learning model bundle; and
a processor to communicate with the memory, the processor to:
unpack the machine learning model bundle to create a machine learning model and extract artifacts of the machine learning model;
determine a behavior of the machine learning model based on sample inputs;
compare the behavior of the machine learning model to expected behavior manifest limits for the machine learning model;
in response to the behavior being below the expected behavior manifest limits, hash the artifacts; and
store the hash of the artifacts in the memory.

2. The information handling system of claim 1, wherein the processor further to: store the machine learning model in a virtualized environment.

3. The information handling system of claim 1, wherein in response to the behavior being above the expected behavior manifest limits, the processor further to: fail an extraction of the machine learning model bundle.

4. The information handling system of claim 1, wherein during a startup of a core application, the processor to: validate the artifacts of the machine learning model against the hash of the artifacts stored in the memory.

5. The information handling system of claim 1, wherein during a startup of a core application, the processor to:
monitor a runtime execution of the machine learning model to determine whether the behavior of the machine learning model matches the expected behavior manifest limits; and
in response to the behavior of the machine learning model matches expected behaviors, quarantine the machine learning model.

6. The information handling system of claim 1, wherein the artifacts are deployed to a protected and isolated location in the memory.

7. The information handling system of claim 1, wherein the machine learning model bundle includes a model runtime code and a signed cabinet file of model artifacts.

8. The information handling system of claim 7, wherein the processor further to:
determine whether the model runtime code has unexpected access to the information handling system; and
in response to the unexpected access, provide a warning to an individual associated with the information handling system.

9. A method comprising:
storing, in an information handling system, a machine learning model bundle;
unpacking, by the information handling system, the machine learning model bundle to create a machine learning model and extract artifacts of the machine learning model;
determining a behavior of the machine learning model based on sample inputs;
comparing the behavior of the machine learning model to expected behavior manifest limits for the machine learning model;
in response to the behavior being below the expected behavior manifest limits, hashing the artifacts; and
storing the hash of the artifacts in the memory.

10. The method of claim 9, further comprising: storing the machine learning model in a virtualized environment.

11. The method of claim 9, wherein in response to the behavior being above the expected behavior manifest limits, the method further comprises: failing an extraction of the machine learning model bundle.

12. The method of claim 9, wherein during a startup of a core application, the method further comprises: validating the artifacts of the machine learning model against the hash of the artifacts stored in the memory.

13. The method of claim 9, wherein during a startup of a core application, the method further comprises:
monitoring a runtime execution of the machine learning model to determine whether the behavior of the machine learning model matches the expected behavior manifest limits; and
in response to the behavior of the machine learning model matching expected behaviors, quarantining the machine learning model.

14. The method of claim 9, wherein the artifacts are deployed to a protected and isolated location in the memory.

15. The method of claim 9, wherein the machine learning model bundle includes a model runtime code and a signed cabinet file of model artifacts.

16. The method of claim 15, further comprising:
determining whether the model runtime code has unexpected access to the information handling system; and
in response to the unexpected access, providing a warning to an individual associated with the information handling system.

17. A system comprising:
a remote server to provide a machine learning model bundle, wherein the machine learning model bundle includes expected behavior manifest limits for a machine learning model; and
an information handling system including:
a machine learning model bundle; and
a first processor to:
unpack the machine learning model bundle to extract the machine learning model and artifacts of the machine learning model;
determine a behavior of the machine learning model based on sample inputs;
compare the behavior of the machine learning model to the expected behavior manifest limits for the machine learning model;
in response to the behavior being below the expected behavior manifest limits, hash the artifacts; and
store the hash of the artifacts in the memory.

18. The system of claim 17, wherein during a startup of a core application, the first processor to: validate the artifacts of the machine learning model against the hash of the artifacts stored in the memory.

19. The system of claim 17, wherein during a startup of a core application, the first processor to:
monitor a runtime execution of the machine learning model to determine whether the behavior of the machine learning model matches the expected behavior manifest limits; and
in response to the behavior of the machine learning model matches expected behaviors, quarantine the machine learning model.

20. The system of claim 17, wherein the remote server includes a second processor, wherein during an execution of a pipeline, the second processor to:
determine scores for components of the machine learning model based on a risk and impact of a machine learning model code; and
in response to each of the scores being above corresponding thresholds, create the expected behavior manifest limits.
